(19) United States
(12) Patent Application Publication
(10) Pub. No.: US 2007/0133682 A1
(43) Pub. Date: Jun. 14, 2007

(54) METHOD OF DETECTING MOTION VECTOR, IMAGE PROCESSING DEVICE, IMAGE DISPLAY APPARATUS, AND PROGRAM

(75) Inventors: Yoshio ARAI, Suwa-shi, Nagano-ken (JP); Tomio IKEGAMI, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/563,859

(22) Filed: Nov. 28, 2006

(30) Foreign Application Priority Data
Dec. 14, 2005 (JP) 2005-359987

(51) Int. Cl. H04N 11/02; H04N 11/04

(52) U.S. Cl. 375/240.16; 375/240.24

(57) ABSTRACT

In a method of detecting a motion vector, each of a plurality of frames constituting an image along a time axis is divided into a plurality of blocks, a motion vector of a target block is detected using a motion vector that has already been detected from another block adjacent to a target block, each of the plurality of the frames is sequentially scanned, and a scanning is performed by shifting the target block from a certain block to another block in each frame, the detection of a motion vector method comprising: shifting the target block from a first block to a second block which is followed by a target block in a first direction; and shifting the target block from a third block to a fourth block which is adjacent to the second block and followed by a target block in a second direction different from the first direction.

### BACKGROUND

1. Technical Field

The invention relates to a technology of detecting a motion vector representing the motion of an object in an image.

2. Related Art

A technology that divides each of a plurality of frames constituting an image along a time axis into a plurality of blocks and detects a motion vector of each block is known in the art. In this technology, the frame is scanned on a block-by-block basis. Through the scanning, each block is selected as a detection of a motion vector target in turn. That is, the detection of a motion vector is sequentially performed for each block. As an example of this technology, a method of using a motion vector that has already been detected in the detection of a motion vector to improve efficiency of detecting an appropriate motion vector has been developed as disclosed in JP-T-11-510937.

In this technology, a block temporally and spatially adjacent to the detection of a motion vector target block among motion vectors that have already been detected is used. The spatially adjacent block means a block adjacent to the target block within the same frame as that of the target block. The temporally adjacent block means a block located in the same position as the target block within a frame adjacent to the frame having the target block. Hereinafter, both blocks are referred to as “adjacent blocks”. In a general image, since appropriate motion vectors are seldom significantly different between a block and its adjacent blocks, most of appropriate motion vectors are temporally and spatially continuous. Therefore, according to the aforementioned related art, the motion vector can be detected with high accuracy.

In the aforementioned related art disclosed in JP-T-11-510937, accuracy of detection of a motion vector of a target block is degraded depending on continuity between a motion vector used in detection of a motion vector of the target block and the motion vector of a target block. This will be described in detail by exemplifying a case in which the detection of a motion vector is performed for a single frame of a tennis ball image, which may be obtained by taking pictures from above a tennis court of a ball moving across the tennis court with a high velocity.

In this case, the still image of a tennis court occupies a lot of block groups within a frame, and a block group surrounded by such block groups may be occupied by an image of a high-velocity ball. In this case, it is assumed that the frame is scanned from the upper left corner thereof to the lower right corner thereof. The target block is shifted from a block positioned in the upper left corner of the frame to the right, one block at a time. When it reaches the rightmost block, the target block is shifted to the leftmost block of the underlying row, and then shifted to the right side again. This shifting is repeated. Therefore, a block used in the detection of a motion vector among adjacent blocks included in the same frame as that of the target block is a block positioned above the target block and a block positioned on the left side of the target block.

In addition, the target block is a block initially targeted within the frame among blocks of a ball image (hereinafter, referred to as a leading ball block). In this case, assuming that the ball is moving down within the frame, the block corresponding to the motion vector following the motion of a ball is included in adjacent blocks within the frame used by the motion vector in the detection of a motion vector of the leading ball block. Therefore, the accuracy of detection of a motion vector for the leading ball block can increase. Meanwhile, assuming that the ball is upwardly moved within the frame, only the block corresponding to the motion vector following the motion of a tennis court, i.e., a motion vector having a magnitude of 0 is included in adjacent blocks within the frame used by the motion vector in the detection of a motion vector of the leading ball block. Therefore, the accuracy of detection of the motion vector of the leading ball block is seriously degraded.

### SUMMARY

An advantage of some aspects of the invention is to provide a method of detecting a motion vector, an image processing device, an image display device, and a program, by which a motion vector representing the motion of an object in an image can be effectively detected with highly reliable accuracy.

According to an aspect of the invention, there is provided a method of detecting a motion vector, in which each of a plurality of frames constituting an image along a time axis is divided into a plurality of blocks, a motion vector of a target block is detected using a motion vector that has already been detected from another block adjacent to a target block, each of the plurality of the frames is sequentially scanned, and a scanning is performed by shifting the target block from a certain block to another block in each frame, the detection of a motion vector method including: shifting the target block from a first block to a second block which is followed by a target block in a first direction; and shifting the target block from a third block to a fourth block which is adjacent to the second block and followed by a target block in a second direction different from the first direction.

In the related art, the accuracy of detection of a motion vector was degraded because an object moving direction is selected at random, but a target block shifting direction between adjacent blocks during the frame scanning (hereinafter, referred to as an adjacent shifting direction) is uniform.

Specifically, the motion vector is usually generated when an object moves across a plurality of frames. Hereinafter, a frame including a detection of a motion vector target block is referred to as “a current frame”, and a frame preceded by the current frame is referred to as “a previous frame”. In this case, the motion vectors of a block spatially adjacent to the target block within the current frame and a block temporally adjacent to the target block within the previous frame are possibly close to the motion vector of the target block. Therefore, it is possible to detect the appropriate motion vector with high accuracy and even a limited processing load by using the motion vector that has already been detected from a block adjacent to the target block (i.e., the adjacent block).

Herein, it is assumed that the target block contains a moving object. In this case, if the motion vector is already detected from a block including an object contained in the target block within the previous frame (hereinafter, referred to as “a previously dominant block) among adjacent blocks, it is possible to detect the motion vector of the target block with high accuracy using this motion vector. In addition, if a motion vector is already detected from a block corresponding to the previously dominant block within the current frame (referred to as “a currently dominant block”), it is possible to detect the motion vector of the target block with high accuracy using this motion vector.

As described above, since the adjacent block includes the previously dominant block and the currently dominant block having high usage on the occasion that the motion vector of the target block is detected, the motion vector should be detected using the motion vectors of these blocks. However, the motion vector of the block within the previous frame is sometimes not detected. This could occur when there is no frame before the previous frame. In this case, the motion vector of the previously dominant block cannot be used. Meanwhile, the motion vector of the block within the current frame can be detected even when there is no frame before the previous frame. Nevertheless, it cannot be said that the motion vector of the currently dominant block is previously detected. The motion vector of the currently dominant block is previously detected only when a moving direction of an object included in the target block is matched with a scan direction (i.e., a target block shifting direction) between the currently dominant block and the target block.

The number of the currently dominant blocks is not limited to 1, but a plurality of blocks are usually used as the currently dominant block. In any case, the accuracy of detection of a motion vector is improved when the motion vector of the currently dominant block is previously detected. As can be seen from an example of a tennis ball, the currently dominant blocks are usually concentrated to a certain direction, and thus, their locations are also concentrated on a certain direction from the target block. Therefore, if the adjacent shifting direction is uniform, a probability that even a single motion vector of the currently dominant block is not previously detected becomes high. As a result, the accuracy of detection of a motion vector is seriously degraded.

For this problem, in the aforementioned detection of a motion vector method, a target block shifting direction to the second block is different from a target block shifting direction to the fourth block adjacent to the second block. Therefore, the adjacent shifting direction is not uniform across the first to fourth blocks. As a result, a probability that even a single motion vector of the currently dominant block is not previously detected is reduced. Therefore, deviation of accuracy of detection of a motion vector is prevented, and the accuracy of detection of a motion vector is stabilized. This effect becomes more significant when the motion vector used in the detection of a motion vector of the target block is limited to the motion vector of the block within the current frame. In addition, according to the aforementioned detection of a motion vector method, the motion vector that has already been detected from the block adjacent to a target block is used when the motion vector of the target block is detected. Therefore, it is possible to effectively detect the appropriate motion vector.

According to the aforementioned detection of a motion vector method, it is possible to effectively detect the motion vector with high accuracy.

When the motion vector that has been detected from the adjacent block is used when a motion vector is detected, if a motion vector of any block is detected with lower accuracy, it may badly affect detection of a motion vector of an adjacent block which uses a corresponding motion vector. Temporal and spatial ranges of this bad effect increase as the detection accuracy is reduced. According to the aforementioned detection of a motion vector method, since it is possible to reduce a probability that even a single motion vector of the currently dominant block is not previously detected, i.e., a probability that accuracy of detection of a motion vector is seriously degraded, the temporal and spatial ranges of the bad effect to the detection of a motion vector due to the low accuracy can be reduced. This advantage may relate to the reduction in the number of frames used to detect the appropriate motion vector among all blocks.

As a method of removing a uniform scan direction, it is conceivable that a plurality of times of scanning is performed for a single frame using different scan directions, and the motion vector may be obtained by synthesizing a plurality of detected motion vectors for each block. However, in this method, the number of detection times that should be performed significantly increases. For this problem, according to the aforementioned detection of a motion vector method, the number of scanning times for a single frame can be limited to 1. Therefore, the number of detection times is not increased but limited. In other words, the aforementioned detection of a motion vector method has a realistic computation load.

In the aforementioned detection of a motion vector method, the scanning may be performed by shifting the target block in a single stroke. When all blocks can be obtained by dividing a frame in a matrix shape, as a method of scanning a single frame, it may be conceivable that a scanning is performed from the left to the right for an upper half of the frame, and a scanning is performed from the right to the left for a lower half of the frame. In this method, the adjacent shifting direction is selected from 2 directions, e.g., the left or right. On the other hand, since the scanning is performed in a single stroke in the embodiment, the adjacent shifting direction is selected from at least 3 directions, e.g., an upper horizontal direction, a lower horizontal direction, a left vertical direction, a right vertical direction, or a horizontal and vertical direction. As can be seen from the above description, according to the embodiment, diversity of the adjacent shifting direction can be sufficiently improved. In addition, since the scan direction is curved several times within the frame, an area where the adjacent shifting direction is diversified can be widened. Furthermore, it the adjacent shifting direction is to be selected from 4 directions, the scanning may be performed in a spiral direction.

In the aforementioned detection of a motion vector method, each frame may be divided such that a plurality of lines obtained by lining up the blocks are adjacent to each other, wherein the scanning for each frame is performed such that blocks to which the target block is shifted in the first direction across the lines and blocks to which the target block is shifted in a direction different from the first direction are alternately arranged on adjacent straight lines that pass through the second and fourth blocks. According to this embodiment, it is possible to reduce concentration of diversity of the adjacent shifting direction within a frame.

In the aforementioned detection of a motion vector method, the first and second blocks may be included in the first frame, the second and fourth blocks may be included in a second frame which is adjacent to and followed by the first frame, wherein the scanning for each frame may be performed such that blocks to which the target block is shifted in the first direction across the frames and blocks to which the target block is shifted in a direction different from the first direction are alternately arranged on adjacent straight lines that pass through the second and fourth blocks. According to this embodiments it is possible to reduce concentration of diversity of the adjacent shifting direction across a plurality of frames.

In the aforementioned detection of a motion vector method, the first block may correspond with the fourth block. According to this embodiment, a target block shifting direction to the fourth block is different from a target block shifting direction from the fourth block. In other words, the scan direction curved in the fourth block. The angle of the curve may depend on how to divide the frame into a plurality of blocks. However, since the curve relates to the scan direction, a curve angle of 180° is not included in this configuration.

According to another aspect of the invention, there is provided an image processing device which generates an interpolation image for compensating for a motion of an object in an image between adjacent frames, the image processing device including: a detection circuit which divides each of a plurality of frames constituting an image along a time axis into a plurality of blocks, detects a motion vector of a target block using a motion vector that has already been detected from another block adjacent to a target block, sequentially scans each of a plurality of the frames, and performs a scanning by shifting the target block from a certain block to another block in each frame; and a generating circuit which generates the interpolation image on the basis of the motion vector detected by the detection circuit, wherein the detection circuit includes: a first shifting unit that shifts the target block from a first block to a second block which is followed by a target block in a first direction; and a second shifting unit that shifts the target block from a third block to a fourth block which is followed by a target block in a second direction different from the first direction and adjacent to the second block.

According to the image processing device of the invention, it is possible effectively detect the motion vector with high accuracy, and it is possible to reduce the number of frames used to detect an appropriate motion vector among all blocks, as mentioned in the above description relating to the detection of a motion vector method. In addition, according to the image processing device, advantages similar to those of the aforementioned detection of a motion vector method can be obtained, i.e., it is possible to perform the detection of a motion vector with a realistic computation load. As a result, according to the image processing apparatus of the invention, it is possible to generate a high quality interpolation image with a realistic computation load just after the interpolation image starts to be generated.

Also, according to still another aspect of the invention, there is provided an image display apparatus including: the image processing device according to claim 6; and an electro-optic device in which a plurality of electro-optic components having a light emitting property or a light-transmitting property changed by received electric energy are arranged so as to form a sheet shape, wherein the interpolation image is displayed such that the light-emitting property or the light-transmitting property of a plurality of the electro-optic components is changed depending on the interpolation image generated by the image processing device.

An electro-optic device having a light-emitting property that can change depending on applied electric energy may include an organic light-emitting diode (OLED) device, an inorganic electroluminescent (EL) device, a field emission (FE) device, a surface conduction electron emitter (SE) device, a ballistic electron surface emitting (BS) device, a light-emitting diode (LED) device, and the like. A device having a light-transmitting property that can change depending on applied electric energy may include a light valve pixel of which the light transmittance is changed by the electric energy, such as a liquid crystal display pixel or an electrophoresis display pixel.

According to the image display apparatus, since the aforementioned image processing device is included, it is possible to safely detect the motion vector with sufficiently high accuracy and a realistic computation load, and it is possible to display a high quality of interpolation image.

According to still another aspect of the invention, there is provided a program that can execute an image processing method which generates an interpolation image for compensating for a motion of an object in an image between adjacent frames, the image processing method including: detecting for which each of a plurality of frames constituting an image along a time axis is divided into a plurality of blocks, a motion vector of a target block is detected using a motion vector that has already been detected from another block adjacent to a target block, each of the plurality of the frames is sequentially scanned, and a scanning is performed by shifting the target block from a certain block to another block in each frame; and generating for which the interpolation image is generated on the basis of the motion vector detected by the detection circuit, wherein the detection of the motion vector includes: a first shifting that shifts the target block from a first block to a second block which is followed by a target block in a first direction; and a second shifting unit that shifts the target block from a third block to a fourth block which is followed by a target block in a second direction different from the first direction and adjacent to the second block.

According to the program, it is possible effectively detect the motion vector with high accuracy, and it is possible to reduce the number of frames used to detect an appropriate motion vector among all blocks, as mentioned in the above description relating to the detection of a motion vector method. In addition, according to the program, advantages similar to those of the aforementioned detection of a motion vector method can be obtained, i.e., it is possible to perform the detection of a motion vector with a realistic computation load. As a result, according to the program of the invention, it is possible to generate a high quality interpolation image with a realistic computation load just after the interpolation image starts to be generated.

### BRIEF DESCRIPTION OF THE DRAWINGS

The invention will be described with reference to the accompanying drawings, wherein like numbers reference like elements.

FIG. 1 is a block diagram illustrating an image display apparatus 1 according to each embodiment of the invention.

FIG. 2 is a diagram for describing generation of interpolation image data in an interpolation image generating circuit 15 included in the image display apparatus 1.

FIG. 3 is a schematic diagram for describing detection of a motion vector performed by a motion vector computing circuit 14 included in the image display apparatus 1.

FIG. 4 is a diagram for describing a typical scan direction.

FIG. 5 is a diagram illustrating an example of a limited search.

FIG. 6 is a diagram for describing a problem in a typical scanning.

FIG. 7 is a diagram for describing a problem that can be generated when an adjacent shifting direction is uniform.

FIG. 8 is a diagram illustrating a scan direction of the motion vector scanning circuit 14A according to the first embodiment of the invention.

FIG. 9 is a flowchart illustrating a detection of a motion vector process according to the first embodiment of the invention.

FIG. 10 is a diagram illustrating a state that a motion vector is detected by a motion vector computing circuit 14A.

FIG. 11 is a diagram illustrating a scan direction according to a modification of the first embodiment of the invention.

FIG. 12 is a diagram illustrating a scan direction according to another modification of the first embodiment of the invention.

FIG. 13 is a diagram illustrating a scan direction obtained by a motion vector computing circuit 14B according to the second embodiment of the invention.

FIG. 14 is a flowchart illustrating a detection of a motion vector process according to the second embodiment of the invention.

FIG. 15 is a perspective view illustrating a mobile personal computer having the image display apparatus 1 as a display unit.

FIG. 16 is a perspective view illustrating a mobile phone having the image display apparatus 1 as a display unit.

FIG. 17 is a perspective view illustrating a personal digital assistants (PDA) device having the image display apparatus 1 as a display unit.

### DESCRIPTION OF EXEMPLARY EMBODIMENTS

Hereinafter, two exemplary embodiments of the invention will be described in detail with reference to the accompanying drawings. In reference numerals in each drawing, “A” and “B” denote first and second embodiments, respectively. In the following description, elements common to the embodiments will be described, and then, unique elements of each embodiment will be sequentially described.

Elements Common to all Embodiments

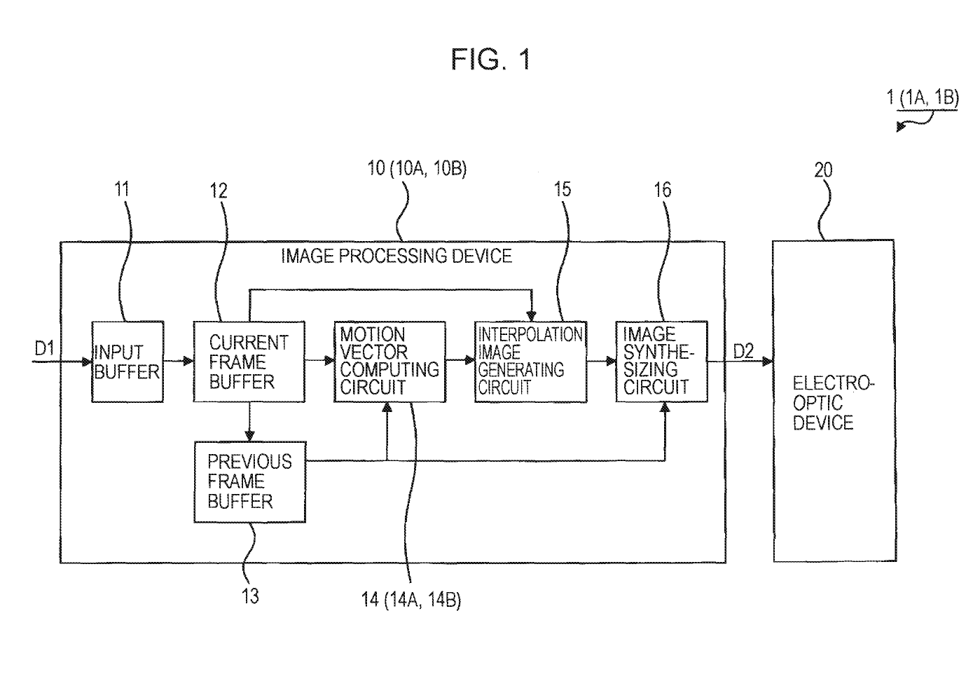

FIG. 1 is a block diagram illustrating an image display apparatus 1 (1A and 1B) according to the embodiments of the invention. The image display apparatus 1 receives an image having a low frame rate of 60 Hz, and converts it into an image having a high frame rate of 120 Hz by performing frame interpolation to display it. The image display apparatus 1 includes an image processing device 10 (10A and 10B) and an electro-optic device 20. The image processing device 10 converts image data D1 corresponding to images of a low frame rate into image data D2 corresponding to images of a high frame rate by performing frame interpolation, and outputs them. The frames of the image data D1 and D2 have the same size.

The electro-optic device 20 is a hold-type display device in which a plurality of electro-optic components having a light-emitting property or a light-transmitting property that can be changed by received electric energy are arranged to form a sheet shape. The electro-optic device 20 receives the image data D2 output from the image processing device 10, and changes the light-emitting properties or the light-transmitting properties of the plurality of electro-optic components depending on the image data D2 to display an image corresponding to the image data D2. The electro-optic device 20 may include light-emitting components such as OLEDs.

In the hold-type display device, a contour of an object recognized by a viewer may become obscure (hereinafter, this phenomenon is called “a moving picture blotch”) due to deviation between movement of an object included in an image and movement of a viewpoint of a viewer tracking the movement of an object. In order to remove the moving picture blotch, a method has been proposed in which the gradation levels of each light-emitting component are not constantly maintained during the entire frame period, but each light-transmitting component intermittently emits light, like an impulse-type display device such as a cathode ray tube (CRT) display. When there is an interval between each light emission period of each light-emitting component, a flickering phenomenon in which the brightness of the entire image periodically fluctuates becomes serious. According to one of the embodiments of the invention, the frame rate of an image is increased by performing frame interpolation in order to prevent the moving picture blotch and the flickering.

The image processing device 10 includes an input buffer 11, a current frame buffer 12, a previous frame buffer 13, a motion vector computing circuit 14 (14A and 14B), an interpolation image generating circuit 15, and an image synthesizing circuit 16. The input buffer 11 receives the image data D1 and outputs the image data D1 in the unit of a frame. The current frame buffer 12 stores the most recent frame output from the input buffer 11, i.e., the image data of the current frame. Just before the current frame buffer 12 starts to store the most recent image data, the previous frame buffer 13 starts to store the image data stored in the current frame buffer 12. That is, the previous frame buffer 13 stores the image data of the previous frame.

The motion vector computing circuit 14 detects a motion vector representing the motion of an object from the previous frame to the current frame on the basis of the image data of the current frame and the previous frame. The interpolation image generating circuit 15 generates and outputs interpolation image data. The motion vector computing circuit 14 and the interpolation image generating circuit 15 are implemented by means of a digital signal processor (DSP) or a computer program executed according to one of the embodiments.

The interpolation image data generated by the interpolation image generating circuit 15 represents an image of an intermediate frame (hereinafter, referred to as an interpolation image) inserted between the previous frame and the current frame. Since such insertion is performed to compensate for the motion of an object in an image, the motion compensation is required to generate the interpolation image data. According to one of the embodiments of the invention, the interpolation image data is generated using the motion vector detected by the motion vector computing circuit 14 and the image data of the current frame. The image synthesizing circuit 16 alternately outputs previous frame image data updated every 1/60 second, and the interpolation image data generated every 1/60 second. As a result, the image data DA is output. The frame of the interpolation image data in the image data D2 is inserted between adjacent frames of the image data D1.

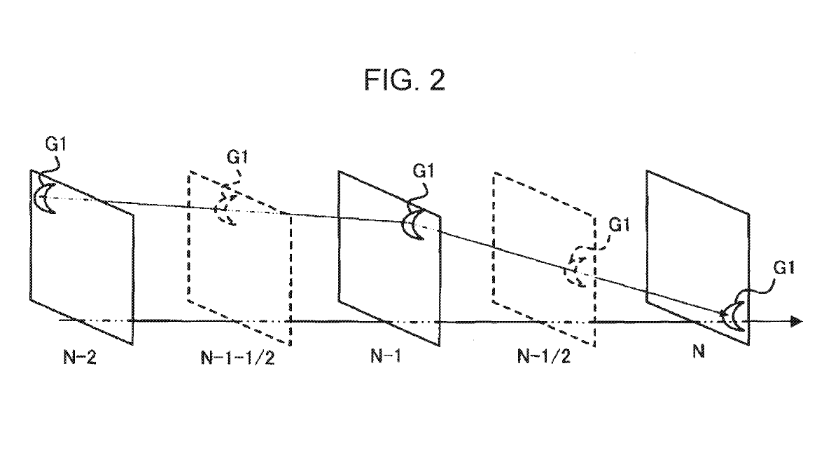

FIG. 2 is a diagram describing generation of interpolation image data by an interpolation imaqe generating circuit 15. Referring to FIG. 2, the (N−1/2)th frame generated by the interpolation image generating circuit 15 is inserted between the Nth frame and the (N−1)th frame adjacent to each other for the image upon which frame interpolation is to be performed. As shown in the drawing, in order to compensate for the motion of an object in an image, the interpolation image data of the (N−1/2)th frame is generated such that the object G1 corresponding to the (N−1/2)th frame is positioned on a straight line representing the motion of the object G1 between the (N−1)th frame and the Nth frame. That is, it is important to appropriately detect the straight line or the motion vector obtained by projecting the straight line onto the frame.

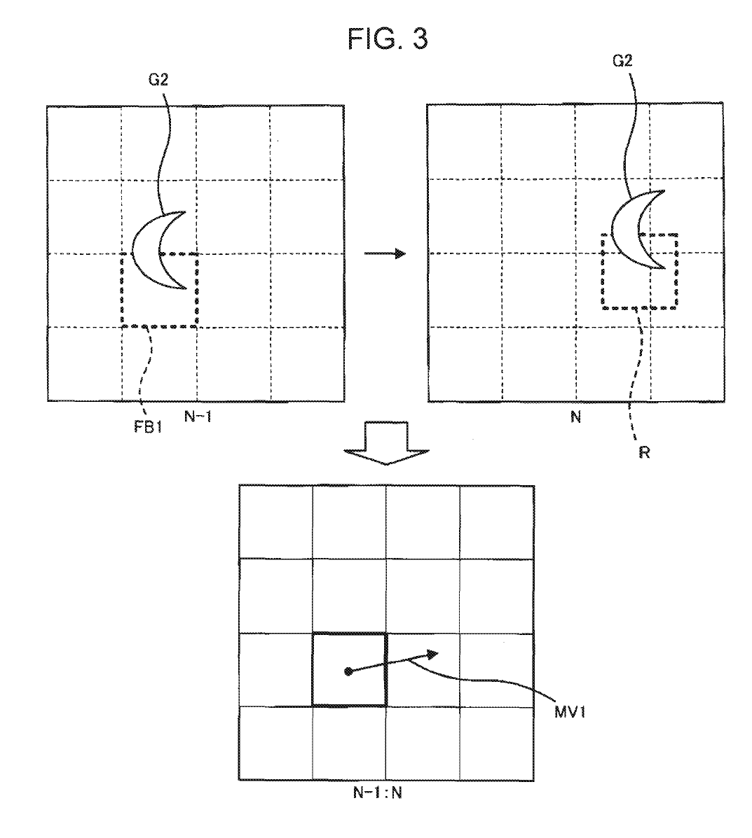

FIG. 3 is a schematic diagram for describing detection of a motion vector performed by a motion vector computing circuit 14. This detection process is performed on the basis of a block matching method known in the art. When the motion vector representing the motion of an object from the previous frame to the current frame is detected using the block matching method, the previous frame is divided into a plurality of blocks having the same shape and size, and the motion vector is detected from among the blocks. In order to detect the motion vector from each block, while a search operation for defining an area having the same shape and size as those of the target block is performed among blocks of the current frame on a block-by-block basis, an image of the defined area is compared with an image of the target block, and the motion vector of the target block is determined on the basis of the comparison result. The method of defining and comparing the area and the image may be arbitrarily selected. For example, the motion vector may be determined in such a way that an absolute difference sum is obtained by summing absolute values of differences in gradation value between pixels of a corresponding location for all pixels, a single area having the minimum absolute difference sum is selected, and a motion vector is determined by selecting the center of this area as a termination point and selecting the center of a processing target block as a start point. Alternatively, the motion vector may be determined in the following manner. Pixels having the same gradation level as that of the corresponding location are counted, the area having the highest pixel count value is selected, and the motion vector is determined by selecting the center of this area as a termination point and selecting the center of a processing target block as a start point. In addition, the motion vector may not be determined when the absolute difference sum for a particular area is smaller than a predetermined reference value, or when the pixel count value is equal to or larger than a predetermined reference value.

FIG. 3 illustrates an example of detecting the motion vector representing the motion of an object G2 from the (N−1)th frame to the Nth frame. In this example, the search of the area is performed by moving an area in the Nth frame by a single pixel or a plurality of pixels. Finally, an area R is defined. In FIG. 3, the motion vector V1 obtained through the aforementioned process is mapped onto a virtual vector map. Since this vector map is obtained by overlapping the (N−1)th frame with the Nth frame, the center of each block corresponds to the start point of the motion vector of a target block. As recognized from the drawing, the motion vector MV1 represents the motion of an object G2 because a part of the object G2 is included in the block FB1.

Examples of the search method are a wide area search and a limited search (e.g., a fluctuation limited search). The wide area search has a wide search range. While the wide area search can detect the motion vector that fluctuates markedly because it has a wide search range, the processing load increases as the number of image comparison processes increases. While the limited search cannot detect the motion vector that fluctuates markedly because it has a narrow search range, the processing load can be reduced as the number of image comparison processes is reduced. The motion vector computing circuit 14 performs not the wide area search but the limited search.

The limited search is based on a fact that the probability that the motion of the object significantly changes between adjacent blocks is very low. The search range is defined with reference to the motion vector that has already been detected for an adjacent block, so that the motion vector can be detected with high accuracy even by using a narrow search range. Therefore, in order to perform the limited search, an adjacent block where the motion vector has already been detected should be provided. This may be obtained by sequentially scanning each frame on a block-by-block basis.

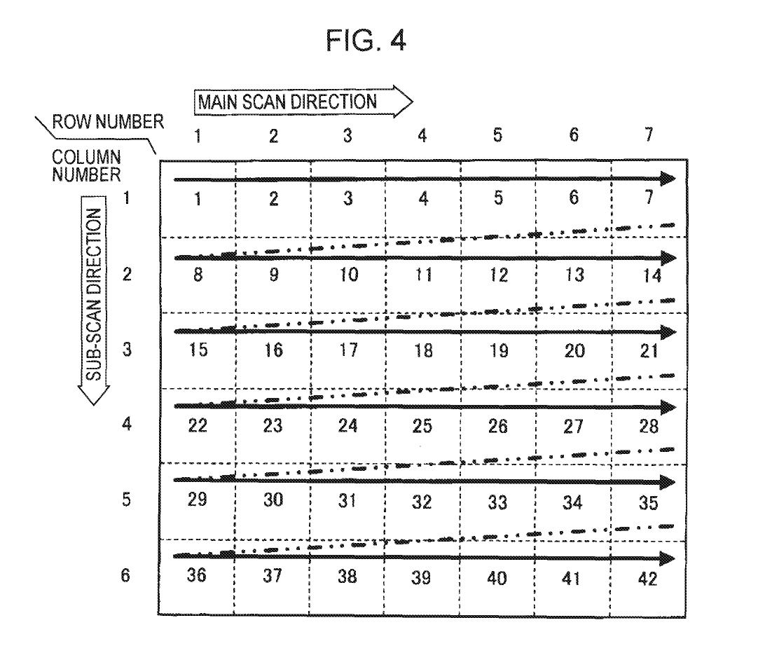

FIG. 4 is a diagram for describing a typical scan direction. As shown in FIG. 4, a typical scanning proceeds from the upper left corner of the frame to the lower right corner of the frame by selecting the row direction of the blocks (i.e., a horizontal direction) as a main scan direction and the column direction of the blocks (i.e., a vertical direction) as a sub-scan direction. Main scanning is performed in ascending order of the column number, and sub-scanning is performed in ascending order of the row number. Specifically the target block is shifted in ascending order, for examples a block positioned in the first row and the first column to a block positioned in the first row and the second column to a block positioned in the first row and the third column to . . . , to a block positioned in the first row and the seventh column to a block positioned in the second row and the first column to a block positioned in the second row and the second column to . . . , to a block positioned in the sixth row and the seventh column.

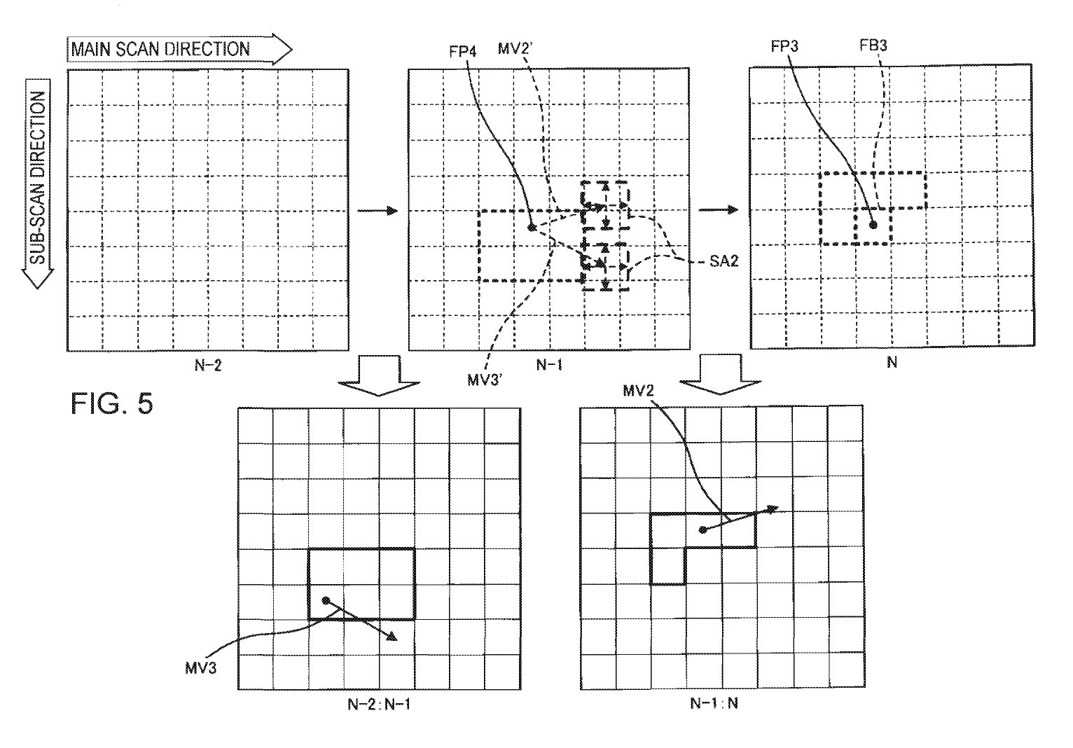

FIG. 5 is a diagram illustrating an example of a limited search. FIG. 5 shows a case in which a motion vector representing the motion of a block FB3 from the (N−1)th frame to the Nth frame is detected under a typical scanning condition. In this case, the motion vectors of 4 adjacent blocks (including the motion vector MV2) within the Nth frame have already been detected. Therefore, a representative vector MV2′ for defining the search range can be determined with reference to these motion vectors. The method of determining the representative vector from 4 motion vectors may be arbitrarily selected. In addition, the number of adjacent blocks from which the motion vectors are referenced within the same frame is not limited to 4.

on the other hand, since the motion vectors (including the motion vector MV3) of 6 adjacent blocks within the (N−1)th frame have already been detected, the representative vector MV3′ can be determined with reference to these motion vectors. The method of determining the representative vector from 6 motion vectors may be arbitrarily selected. In addition, the number of adjacent blocks from which the motion vectors are referenced within the same frame is not limited to 6.

Subsequently, locations of the termination points of the representative vectors MV2′ and MV3′ are obtained by using the point FP4 corresponding to the center point FP3 of the block FB3 within the (N−1)th frame as a start point, and the search range SA2 is defined around each location. The search range SA2 is wider than a single block by 1 to 3 pixels in both longitudinal and lateral directions. FIG. 5 is provided as just an example, and the number of representative vectors is not limited to 2. Also, the area of the search range is not limited as described above.

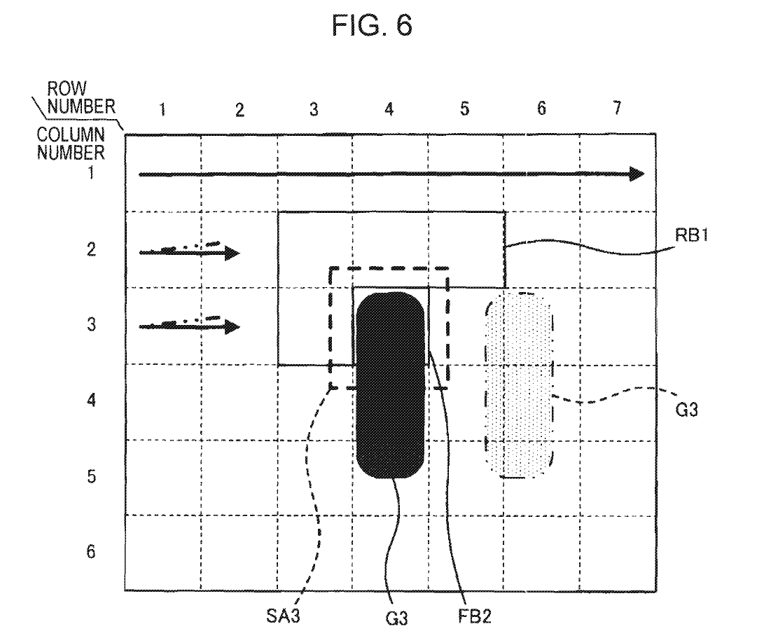

FIG. 6 is a diagram describing a problem that occurs during a typical scanning. The current frame shown in FIG. 6 is a second frame in an image. Therefore, the block from which the motion vector has already been detected is limitedly selected from the blocks within the current frame. In addition, the current frame is divided into 6 rows and 7 columns of blocks, and the block positioned in the third row and the fourth column is a target block FB2. In the current frame, an object G3 occupies across three blocks positioned in the third, fourth, and fifth rows and the fourth column. The object G3 previously occupied across 6 blocks positioned in the third, fourth, and fifth rows and the fifth and sixth columns.

As described above, the scanning is performed from the upper left corner to the lower right corner of the frame by selecting the row direction as a main scan direction and the column direction as a subsidiary scan direction. Therefore, an adjacent shifting direction which means a shifting direction of a target block across adjacent blocks within the same frame is a direction from left to right for a frame. That is, the adjacent shifting direction within a frame is uniform. In this scanning, the motion vector is limitedly detected from among only three blocks positioned above the target block FB2 and a single block positioned on the left side of the target block FB2 within the current frame. Therefore, when the motion vector of the target block FB2 is detected, such a block functions as a reference block RB1, and its motion vector is referenced. Since a moving object is not provided in the reference block RB1, the magnitude of the motion vector becomes zero. Therefore, an appropriate motion vector cannot be detected from the search range SA3 of the previous frame, defined on the basis of the motion vector of the reference block RB1.

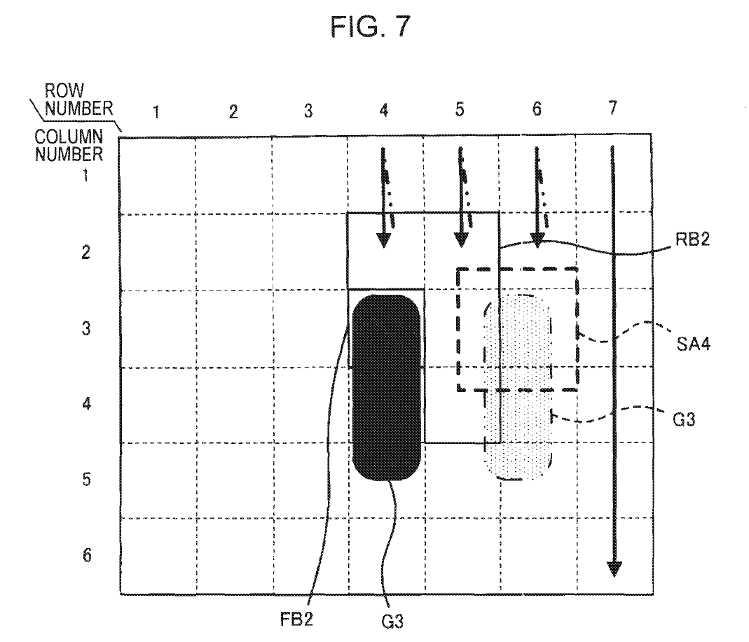

FIG. 7 is a diagram describing a problem that can occur when the adjacent shifting direction is uniform. FIG. 7 is different from FIG. 6 in that the scanning is performed from the upper right corner of the frame to the lower left corner of the frame by selecting the vertical direction as a main scan direction and selecting the horizontal direction as a sub-scan direction. In the example of FIG. 7, the motion vector is limitedly detected from 3 blocks positioned on the right side of the target block FB2 and a single block positioned above the target block FB2 within the current frame. Therefore, when the motion vector of the target block FB2 is detected, such a block functions as a reference block RB2, and its motion vector is referenced. Since the reference block RB2 has a moving object G3, its motion vector corresponds to the motion of the object G3. Therefore, an appropriate motion vector can be detected using the search range SA4 within the previous frame, which is defined on the basis of the motion vector of the reference block RB2.

However, a case in which the appropriate motion vector can be detected as shown in FIG. 7 is just accidental. For example, if the object G3 moves from right to left, the accuracy of detection of a motion vector is seriously degraded. Such a significant difference in the detection accuracy is because the adjacent shifting direction is uniform. A currently dominant block is a block of the previous frame having the object included in the target block among adjacent blocks within the same frame as that of the target block. Since the currently dominant blocks are apt to be concentrated. If the adjacent shifting direction is uniform, a probability that even a single motion vector is not detected from the currently dominant block increases, and the detection accuracy possibly becomes seriously degraded. This probability becomes significant when the motion vector that has already been detected from the previous block cannot be used, and particularly, when the second frame corresponds to the current frame.

Under the limited search condition, when the accuracy of detection of a motion vector of the target block is degraded, its negative effect influences the quality of a lot of subsequent interpolation images as well as the quality of the interpolation image between the previous frame and the current frame. Therefore, the moving picture blotch may not be removed, and additional problems may arise. In this case, according to one of the embodiments of the invention, the motion vector computing circuit 14 which performs the limited search is operated so as to allow the adjacent shifting direction not to be uniform, so that the detection accuracy difference can be limited.

### First Embodiment

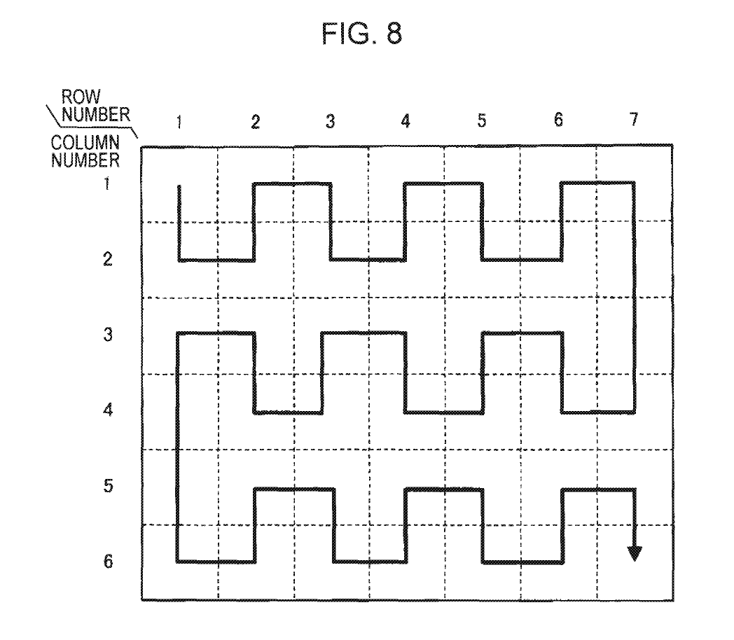

FIG. 8 is a diagram illustrating a scan direction of the motion vector scanning circuit 14A according to the first embodiment of the invention. As can be seen from FIG. 8, according to the embodiment, the frame is divided into 6 rows and 7 columns of blocks. Since the scan direction shown in the drawing is determined such that all the blocks in the frame are scanned in a single stroke, the destination for shifting the target block should be adjacent to the source of the shifting. A target block advancing direction is different from a target block retreating direction for 36 blocks excluding the first block, the block positioned in the second row and the seventh column, the block positioned in the third row and the seventh column, the block positioned in the fourth row and the first column, the block positioned in the fifth row and the first column, and the last block in this scan direction. Specifically, the scan direction is perpendicularly changed in these blocks.

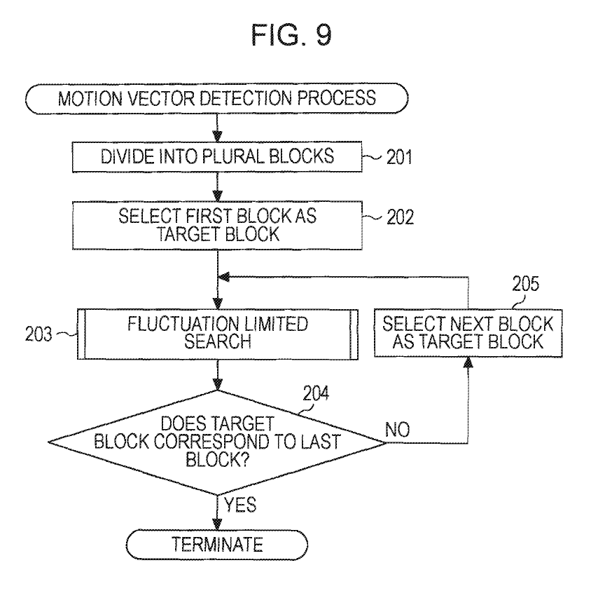

FIG. 9 is a flowchart illustrating a detection of a motion vector process according to the first embodiment of the invention. The detection of a motion vector process is for detecting the motion vector of a single frame. The detection of a motion vector performed by the motion vector computing circuit 14A starts after the image data of the previous frame is stored in the previous frame buffer 13, that is, after the second frame becomes the current frame.

As shown in the drawing, the motion vector computing circuit 14A divides the previous frame into a plurality of blocks (step 20L). Specifically, the number of rows and columns (e.g., 6 and 7) of the blocks included in a single frame are set. In addition, since the numbers of rows and columns are constant, it is not necessary to perform the setting for each frame, but it may be performed for the first frame. Then, the motion vector computing circuit 14A selects the first block as the target block (step 202). For example, this may be performed by setting the row number as 1 and the column number as 1 in a predetermined memory area.

Subsequently, the motion vector computing circuit 14A detects the motion vector from the target block through the limited search (step 203). Then, it is determined whether or not the target block corresponds to the last block (step 204). For example, this determination may be performed by comparing the row number and the column number stored in a predetermined memory area with 6 and 7, respectively. If the comparison result shows that the row number and the column number are identical to those stored in the memory area,“YES” is determined. If “NO” is determined as a result of the determination, the motion vector computing circuit 14A selects the next block in the scan direction of FIG. 8 as the target block (step 205). That is, the target block is shifted to the next block. Specifically, the row number and the column number stored in the predetermined memory area are updated. Then, the process returns to step 203, and steps 203 to 205 are repeated. As a result of the repeated steps 203 to 205, the row number and the column number stored in the predetermined memory area are repeatedly updated. This update is performed by setting the scan direction of the motion vector computing circuit 14A as that shown in FIG. 8. When “YES” is determined as a result of step 204, the repetition of steps 203 to 205 is completed, and the detection of a motion vector process is terminated.

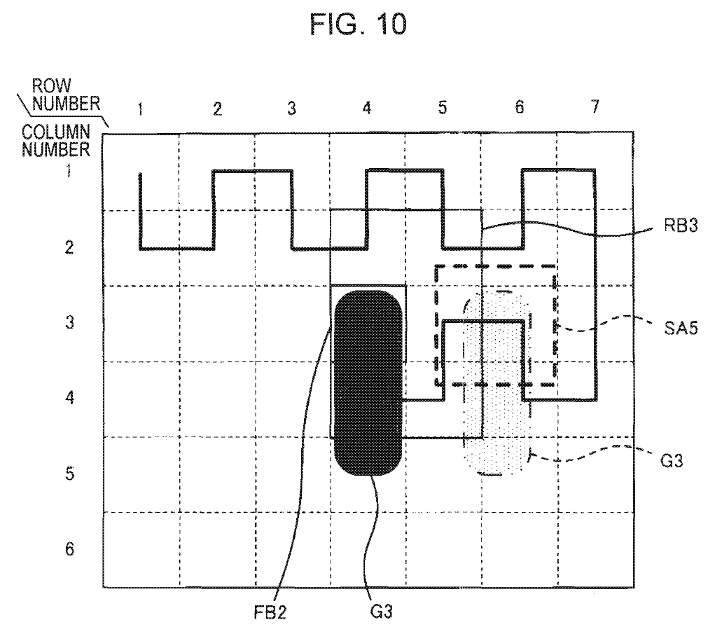

FIG. 10 is a diagram illustrating a state in which a motion vector is detected by a motion vector computing circuit 14A. The images and frames of FIGS. 6 and 7 are similarly applied to FIG. 10. In FIG. 10, the motion vector has already been detected from 3 blocks positioned on the right side of the target block FB2, a block positioned above the target block FB2, and a block positioned beneath the target block FB2 within the current frame. Therefore, these blocks function as reference blocks RBs to reference the motion vector when the motion vector is detected from the target block FB2. Since a moving object G3 exists in the reference block RB3, the motion vector corresponds to the motion of the object G3. Therefore, it is possible to detect an appropriate motion vector using the search range SA5 within the previous frame, defined on the basis of the motion vector of the reference block RB3.

As described above, when scanning is performed by the motion vector computing circuit 14A, a shifting direction from the first block (for example, a block positioned in the third row and the sixth column) to the second block (for example, a block positioned in the third row and the fifth column) is different from a shifting direction from the third block (for example, a block positioned in the fourth row and the fourth column) to the fourth block (for example, a block positioned in the third row and the fourth column) adjacent to the second block. Therefore, the adjacent shifting direction is not uniform across the first to fourth blocks. As a result, a probability that the currently dominant block (for example, a block positioned in the third row and the fifth column in FIG. 10) has already been detected increases. Therefore, the difference in the accuracy of detection of a motion vector is limited, and the accuracy of detection of a motion vector can be stabilized.

According to the motion vector computing circuit 14A, since the probability that the currently dominant block has already been detected is increased, it is possible that the accuracy of detection of a motion vector is not significantly degraded even when the second frame corresponds to the current frame, i.e., even when the current motion vector used when the motion vector of the target block is detected is limited to the motion vector of the block within the current frame. Therefore, it is possible to reduce the number of frames used to detect an appropriate motion vector among all blocks.

According to the motion vector computing circuit 14A, since all the blocks in the frame are scanned in a single stroke, the scan direction changes several times within the frame. Specifically, the scan direction is perpendicularly changed for each of 36 blocks. For this reason, a large diversity of the adjacent shifting direction and an area where the adjacent shifting direction is not uniform can be obtained. Specifically, the adjacent shifting direction can be up, down, left, and right, and the area where the adjacent shifting direction is not uniform extends across the entire frame. According to the motion vector computing circuit 14A, the limited search is performed, and the number of scans for a single frame is set to 1. Therefore, it is possible to effectively detect the motion vector with a realistic computation load.

As a modification of the embodiment, the scanning is directed from left to right for the upper half of the frame, and the scanning is directed from right to left for the lower half. In this apparatus, while the adjacent shifting direction is diversified near a border between the upper and lower halves, the adjacent shifting direction is not diversified in other areas. That is, the diversity is significantly biased. For this problem, in the scanning of the motion vector computing circuit 14A, the blocks to which the target block is shifted in a particular direction and the blocks to which the target block is shifted in a direction different from the particular direction are alternately arranged on a straight line extending across rows or columns. For blocks positioned in the third column, the adjacent shifting direction is right in the first row, down in the second row, left in the third row, down in the fourth row, right in the fifth row, and down in the sixth row. As can be seen from the above description, according to the motion vector computing circuit 14A, spatial concentration of diversity can be attenuated. This would contribute to the reduction in the number of frames used to detect an appropriate motion vector among all blocks.

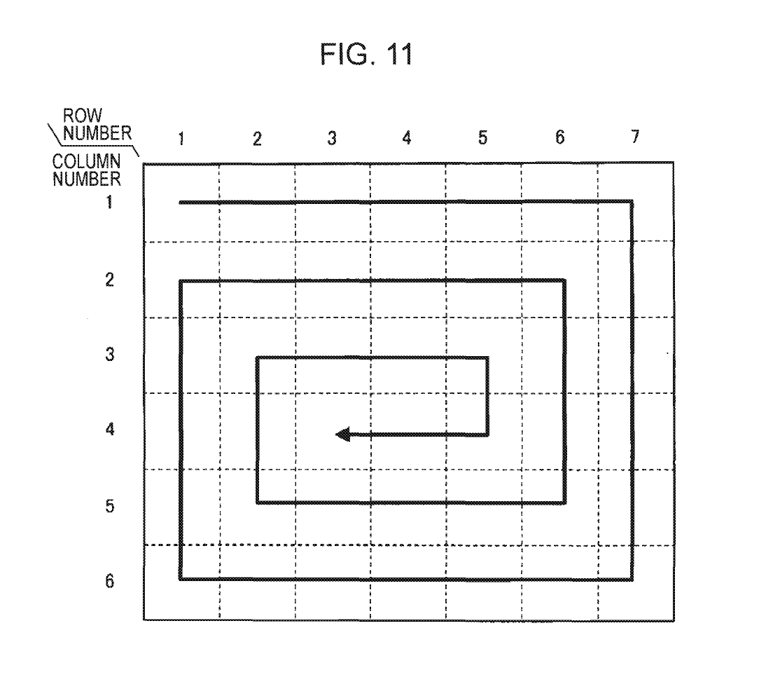

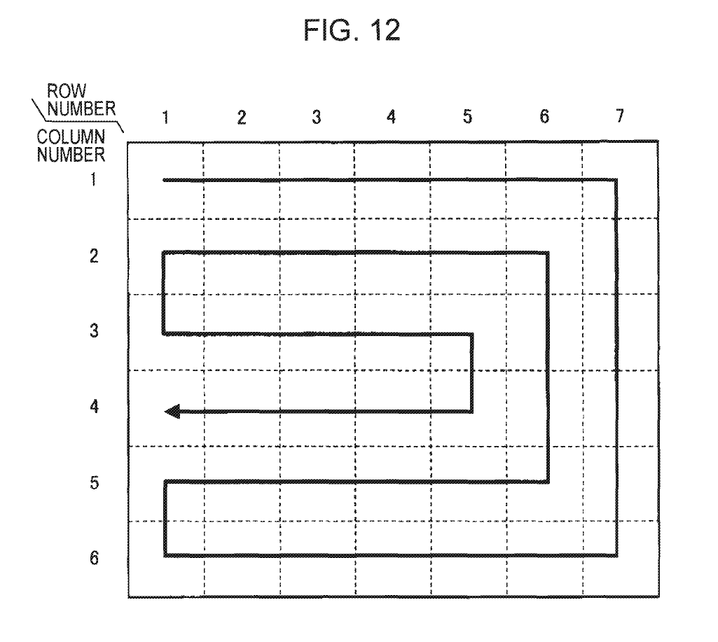

FIGS. 11 and 12 are diagrams illustrating a scan direction according to a modification of the first embodiment of the invention. As shown in the drawing, the scan direction may be a spiral shape or a side-opened rectangular shape by modifying the first embodiment. Furthermore, the scan direction may be reversed, and the scan directions may be divided in such a way that the rows in which the scanning is performed in a right direction and the rows in which the scanning is performed in a left direction are alternately arranged. Similarly, the scan direction may be divided in such a way that the columns in which the scanning is performed in an up direction and the columns in which the scanning is performed in a down direction are alternately arranged.

As described above, since the image processing device 10A includes the motion vector computing circuit 14A and the interpolation image generating circuit 15 which generates the interpolation image data using the motion vector detected by the motion vector computing circuit 14, it is possible to generate the interpolation image data having high quality with a realistic computation load in comparison with an image processing device that does not have the motion vector computing circuit 14A. According to the image processing device 10A, the image data D1 having a frame rate of 60 Hz is received, the interpolation image data having high quality is generated from the image data D1, and frame interpolation is performed. As a result, it is possible to generate the image data D2 having a high frame rate of 120 Hz. That is, it is possible to generate the image data D1 having high quality from the image data D1 in comparison with the image data having a frame rate of 120 Hz generated by the image processing device that does not have the motion vector computing circuit 14.

In addition, since the image display apparatus 1A includes the image processing device 10A and the electro-optic device 20 which receives the interpolation image data generated by the image processing device 10A and displays the interpolation image represented by this data, it is possible to generate the interpolation image data having high quality with a realistic computation load in comparison with an image display apparatus that does not have the image processing device 10A. In addition, the image display apparatus 1A receives the image data 1 and displays the image obtained using the image data D2. As described above in association with the quality of the image data D2, according to the image display apparatus 1A, it is possible to display a high-quality image in comparison with an image displayed by an image display apparatus that does not have the image processing device 10A using the image data D1. Accordingly, it is possible to prevent moving picture blotch and flickering.

### Second Embodiment

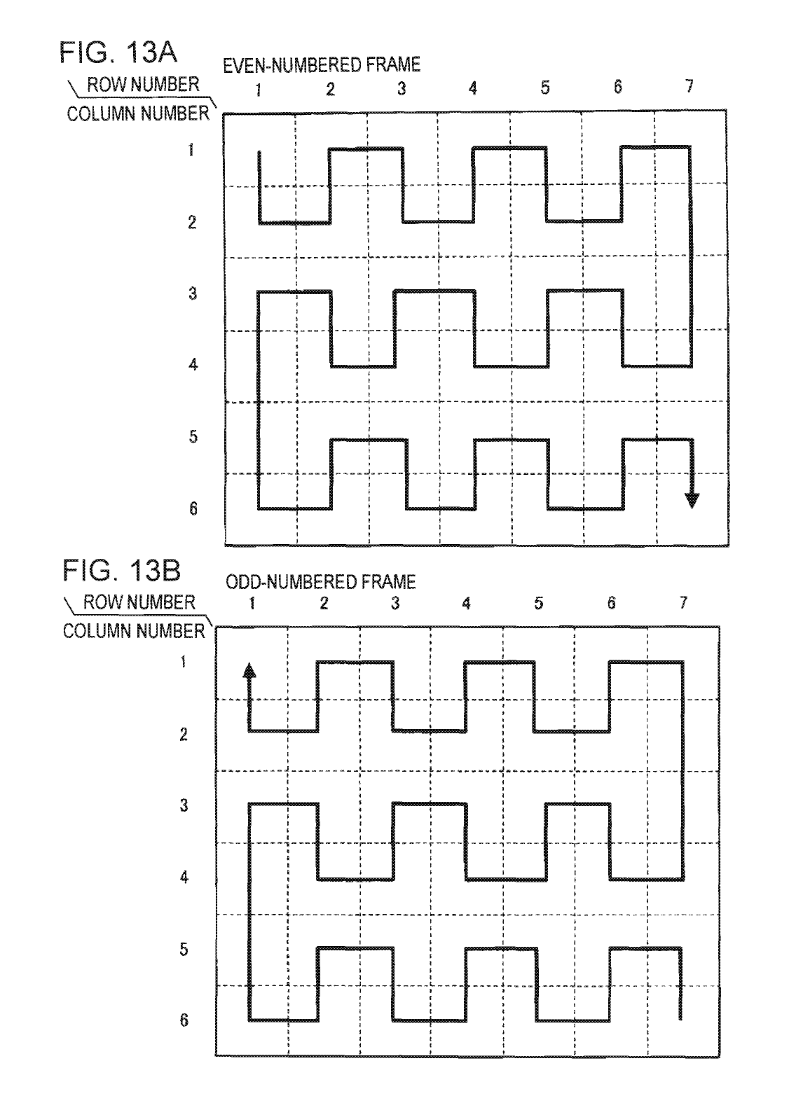

FIG. 13 is a diagram illustrating a scan direction obtained by a motion vector computing circuit 14B according to the second embodiment of the invention. As can be seen in the drawing, the scan direction obtained by the motion vector computing circuit 14B is different between even-numbered frames and odd-numbered frames. The even-numbered frames are a group of frames that become a current frame at the even-numbered times, and the odd-numbered frames are a group of frames that become a current frame at the odd-numbered times. While the scan direction of the even-numbered frames is similar to that obtained by the motion vector computing circuit 14A according to the first embodiment of the invention, the scan direction of the odd-numbered frames is opposite to that of the even-numbered frames. Hereinafter, the scan direction of the even-numbered frames is called “a forward direction”, the scan direction of the odd-numbered frames is called “a reverse direction”.

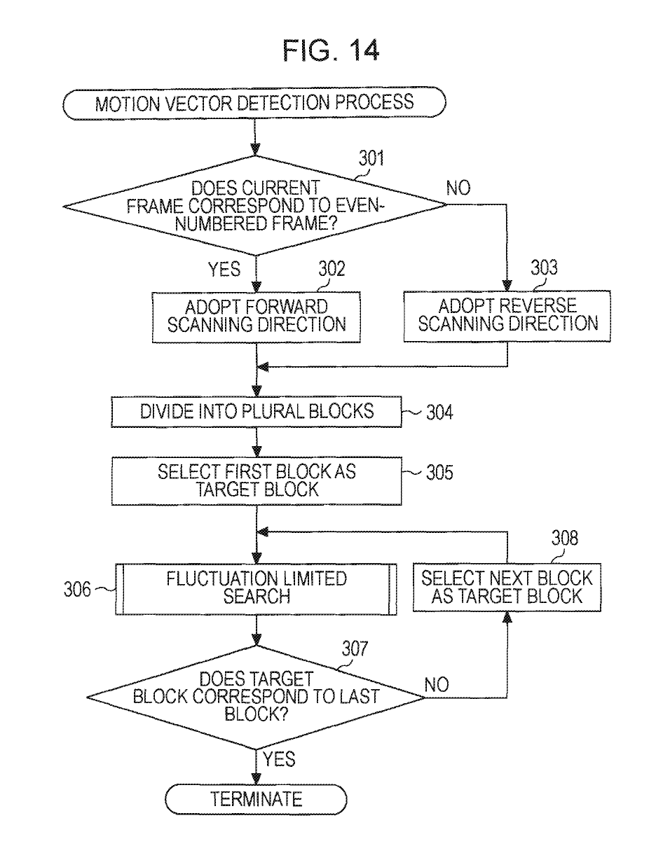

FIG. 14 is a flowchart illustrating a detection of a motion vector process according to the second embodiment of the invention. As shown in the drawing, the motion vector computing circuit 14B determines whether the current frame corresponds to the even-numbered frame or the odd-numbered frame (step 301). If the current frame corresponds to the even-numbered frame, the forward direction is selected as the scan direction. On the contrary, if the current frame corresponds to the odd-numbered frame, the reverse direction is selected as the scan direction (step 302 or 303). Subsequent processes are similar to those of steps 201 to 205 (steps 304 to 308). However, the processes of steps 305, 307, and 308 are appropriately modified according to the selected scan direction.

As described above, in the motion vector computing circuit 14B, the image processing apparatus 10B, or the image display apparatus 1B, it is possible to obtain advantages similar to those obtained from the motion vector computing circuit 14A, the image processing device 10A, and the image display apparatus 1A according to the first embodiment. According to the motion vector computing circuit 14B, since a target block shifting direction to a certain block (hereinafter, referred to as a block A) in the current frame is reversed to a target block retreating direction to the block A in the previous frame, diversity of the adjacent shifting direction across a plurality of frames increases in comparison with the first embodiment. In addition, in the process of the motion vector computing circuit 14B, the blocks to which the target block is shifted in a particular direction and the blocks to which the target block is shifted in a direction different from the particular direction are alternately arranged on a straight line extending across a plurality of frames. Therefore, according to the motion vector computing circuit 14B, temporal concentration of diversity can be attenuated. This would contribute to the reduction in the number of frames used to detect an appropriate motion vector among all blocks.

Similarly to the modifications of the first embodiment the second embodiment may be modified. Although the scan direction is reversed between the even-numbered frames and the odd-numbered frames in the second embodiment, the scan direction is not limited thereto. For example, while the adjacent shifting direction in the scanning for the even-numbered frames may be set to only a lower direction, the adjacent shifting direction in the scanning for the odd-numbered frames may be set to only a right direction. Furthermore, by modifying the embodiment, the target block shifting direction may be identical between the block A and the block B, or the target block shifting direction may be different between the block A and the blocks adjacent to the block B in the previous frame.

Although the frame is divided in a matrix shape, and the block and the frame have a rectangular shape according to the aforementioned embodiments, the invention is not limited thereto. In addition, by modifying the invention, only the previous frame may be used to generate the interpolation image data, or both the previous frame and the current frame may be used. Furthermore, the frame rate may be tripled. Moreover, the length of the image may be increased without changing the frame rate.

Application

Hereinafter, an electric apparatus having the image display apparatus 1 will be described.

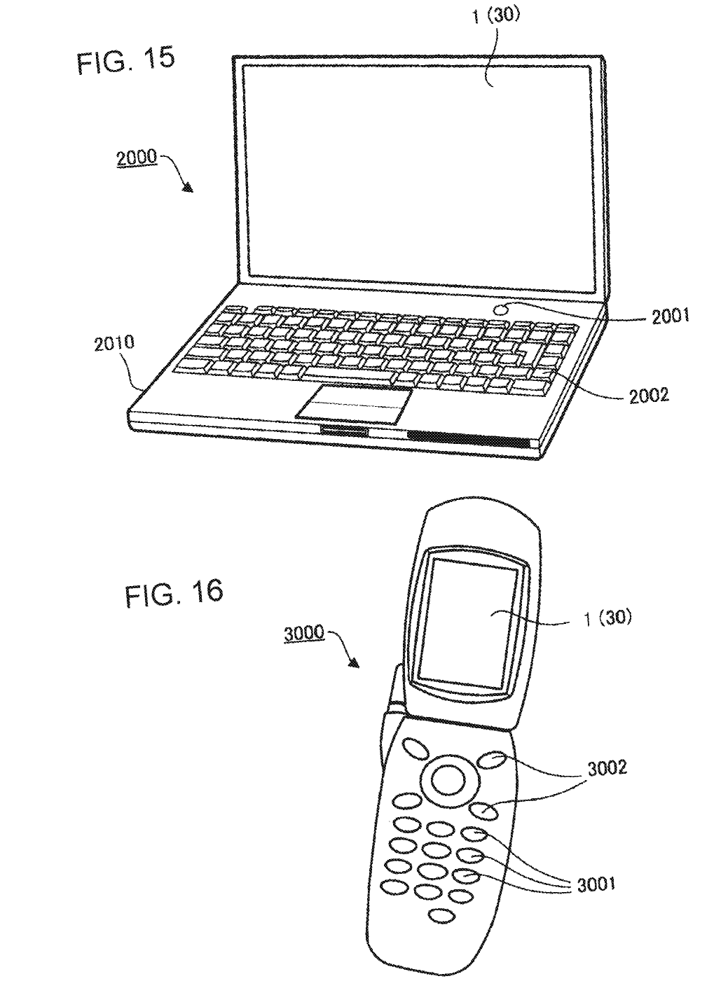

FIG. 15 is a perspective view illustrating a mobile personal computer having the aforementioned image display apparatus 1. The personal computer 2000 includes the image display apparatus as a main body 2010. The main body 2010 has a power switch 2001 and a keyboard 2002. A display panel 30 (corresponding to the image display apparatus 1) of the personal computer 2000 uses an OLED device as the electro-optic component. Therefore, it is possible to provide a wide angle of view and a clear screen.

FIG. 16 is a perspective view illustrating a mobile phone having the image display apparatus 1 according to the invention. The mobile phone 3000 includes a plurality of manipulation buttons 3001, a scroll button 3002, and the image display apparatus 1 as a display unit. A screen displayed on the display panel 30 (corresponding to the image display apparatus 1) is scrolled by manipulating the scroll button 3002.

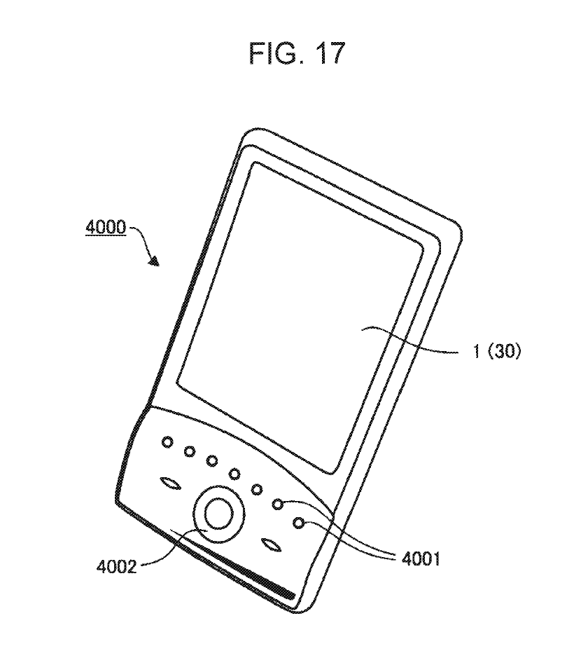

FIG. 17 is a perspective view illustrating a personal digital assistants (PDA) device having the image display apparatus 1 according to the invention. The PDA 4000 includes a plurality of manipulation buttons 4001, a power switch 4002, and the image display apparatus 1 according to the invention. Various information such as an address list or a schedule board is displayed on the display panel 30 of the image display apparatus 1 by manipulating the power switch 4002.

Alternatively, an electric apparatus having the image display apparatus 1 according to the invention may include other display devices such as a television set and a video camera in addition to those shown in FIGS. 15 to 17. Also, an electric apparatus having the image processing device 10 according to the invention may include other image data output devices such as a television set, a video camera, and a video player in addition to those shown in FIGS. 15 to 17.

The entire disclosure of Japanese Patent Application No. 2005-3599387, filed Dec. 14, 2005 is expressly incorporated by reference herein.

What is claimed is:

1. A method of detecting a motion vector, in which each of a plurality of frames constituting an image along a time axis is divided into a plurality of blocks, a motion vector of a target block is detected using a motion vector that has already been detected from another block adjacent to a target block, each of the plurality of the frames is sequentially scanned, and a scanning is performed by shifting the target block from a certain block to another block in each frame, the detection of a motion vector method comprising:
shifting the target block from a first block to a second block which is followed by a target block in a first direction; and
shifting the target block from a third block to a fourth block which is adjacent to the second block and followed by a target block in a second direction different from the first direction.

2. The detection of a motion vector method according to claim 1, wherein the scanning is performed by shifting the target block in a single stroke.

3. The detection of a motion vector method according to claim 1 wherein each of the frames is divided such that a plurality of lines obtained by lining up the blocks are adjacent to each other,
wherein the scanning for each frame is performed such that blocks to which the target block is shifted in the first direction across the lines and blocks to which the target block is shifted in a direction different from the first direction are alternately arranged on adjacent straight lines that pass through the second and fourth blocks.

4. The detection of a motion vector method according to claim 1, wherein the first and second blocks are included in the first frame,
wherein the second and fourth blocks are included in a second frame which is adjacent to and followed by the first frame, and
wherein the scanning for each frame is performed such that blocks to which the target block is shifted in the first direction across the frames and blocks to which the target block is shifted in a direction different from the first direction are alternately arranged on adjacent straight lines that pass through the second and fourth blocks.

5. The detection of a motion vector method according to claim 1, wherein the first block corresponds to the fourth block.

6. An image processing device which generates an interpolation image for compensating for a motion of an object in an image between adjacent frames, the image processing device comprising:
a detection circuit which divides each of a plurality of frames constituting an image along a time axis into a plurality of blocks, detects a motion vector of a target block using a motion vector that has already been detected from another block adjacent to a target block, sequentially scans each of a plurality of the frames, and performs a scanning by shifting the target block from a certain block to another block in each frame; and
a generating circuit which generates the interpolation image on the basis of the motion vector detected by the detection circuit,
wherein the detection circuit includes:
a first shifting unit that shifts the target block from a first block to a second block which is followed by a target block in a first direction; and
a second shifting unit that shifts the target block from a third block to a fourth block which is followed by a target block in a second direction different from the first direction and adjacent to the second block.

7. An image display apparatus comprising:
the image processing device according to claim 6; and
an electro-optic device in which a plurality of electro-optic components having a light-emitting property or a light-transmitting property changed by received electric energy are arranged so as to form a sheet shape;
wherein the interpolation image is displayed such that the light-emitting property or the light-transmitting property of a plurality of the electro-optic components is changed depending on the interpolation image generated by the image processing device.

8. A program that can execute an image processing method which generates an interpolation image for compensating for a motion of an object in an image between adjacent frames, the image processing method comprising:
detecting for which each of a plurality of frames constituting an image along a time axis is divided into a plurality of blocks, a motion vector of a target block is detected using a motion vector that has already been detected from another block adjacent to a targets block, each of the plurality of the frames is sequentially scanned, and a scanning is performed by shifting the target block from a certain block to another block in each frame; and
generating for which the interpolation image is generated on the basis of the motion vector detected by the detection circuit,
wherein the detection of the motion vector includes:
a first shifting that shifts the target block from a first block to a second block which is followed by a target block in a first direction; and
a second shifting that shifts the target block from a third block to a fourth block which is followed by a target block in a second direction different from the first direction and adjacent to the second block.
